(19) United States
(12) Patent Application Publication
(10) Pub. No.: US 2025/0260069 A1
(43) Pub. Date: Aug. 14, 2025

(54) LITHIUM-ION CELL HAVING RIGID STRUCTURE WITH PRESSURE

(71) Applicant: STOREDOT LTD., Herzeliya (IL)

(72) Inventors: Daniel ARONOV, Netanya (IL); David Elmakias, Tel Aviv-Jaffa (IL)

(73) Assignee: STOREDOT LTD., Herzeliya (IL)

(21) Appl. No.: 18/441,994

(22) Filed: Feb. 14, 2024

(51) Int. Cl. H01M 10/42; G05D 16/00; H01M 10/0525; H01M 10/058; H01M 10/613; H01M 50/103; H01M 50/107

(52) U.S. Cl. CPC H01M 10/4235; G05D 16/024; H01M 10/0525; H01M 10/058; H01M 10/425; H01M 10/613; H01M 50/103; H01M 50/107

(57) ABSTRACT

A device that includes an electrochemical cell that includes a rigid housing, electrodes that comprises an anode, a cathode, and an adjustable pressure element configured to assert a controlled pressure on at least one of the electrodes. The controlled pressure is set to a first value during a first point in time and is set to a second value during a second point in time. The electrodes and the adjustable pressure element are located within the rigid housing.

Graphite, silicon and lithium metal are common anode materials used in lithium-ion batteries. Silicon and Lithium metal have a much higher theoretical capacity than graphite, but it also undergoes significant volume expansion and contraction during lithiation and de-lithiation cycles. This can lead to mechanical stress, particle cracking, electrolyte interface instability and lithium dendrite growth, which can reduce the battery's lifespan. Graphite, on the other hand, has a lower theoretical capacity than silicon or lithium metal, but it is much more stable and does not undergo significant volume changes. There is a growing need to reduce the mechanical stress and particle cracking.

### SUMMARY

There is provided a method and a device for applying controlled pressure.

### BRIEF DESCRIPTION

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

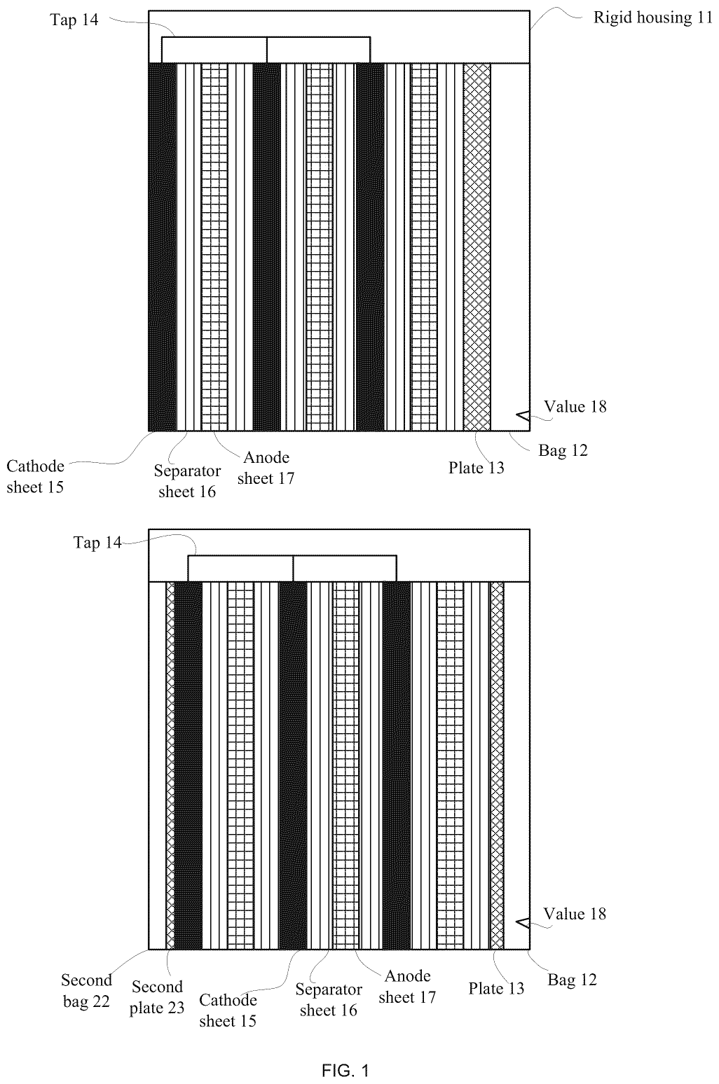

FIGS. 1-3 illustrate examples of cross sections of prismatic electrochemical cells that includes electrodes and separator sheets;

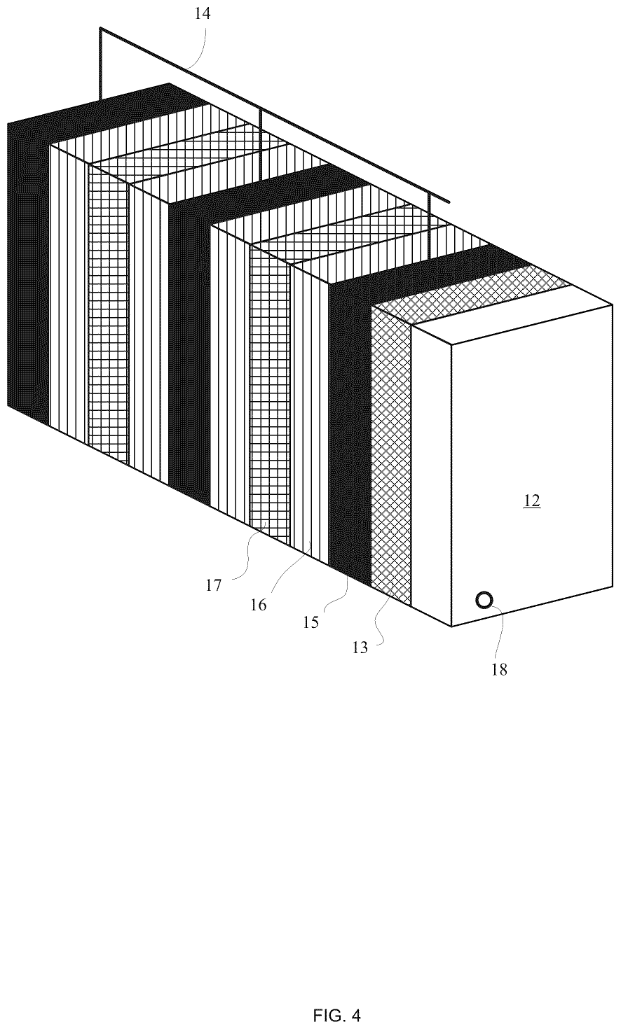

FIG. 4 illustrates an example of a prismatic electrochemical cell without its rigid housing;

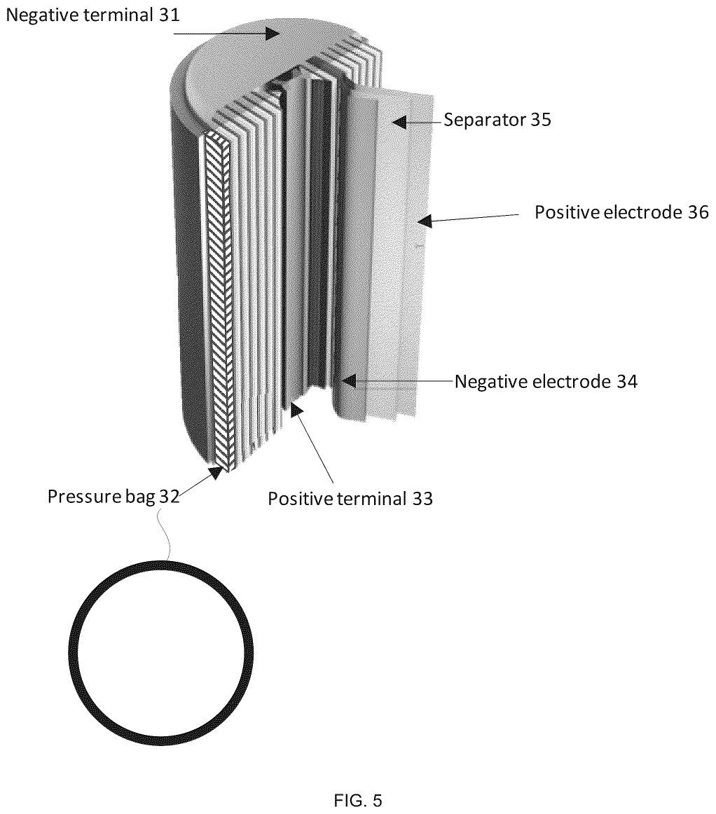

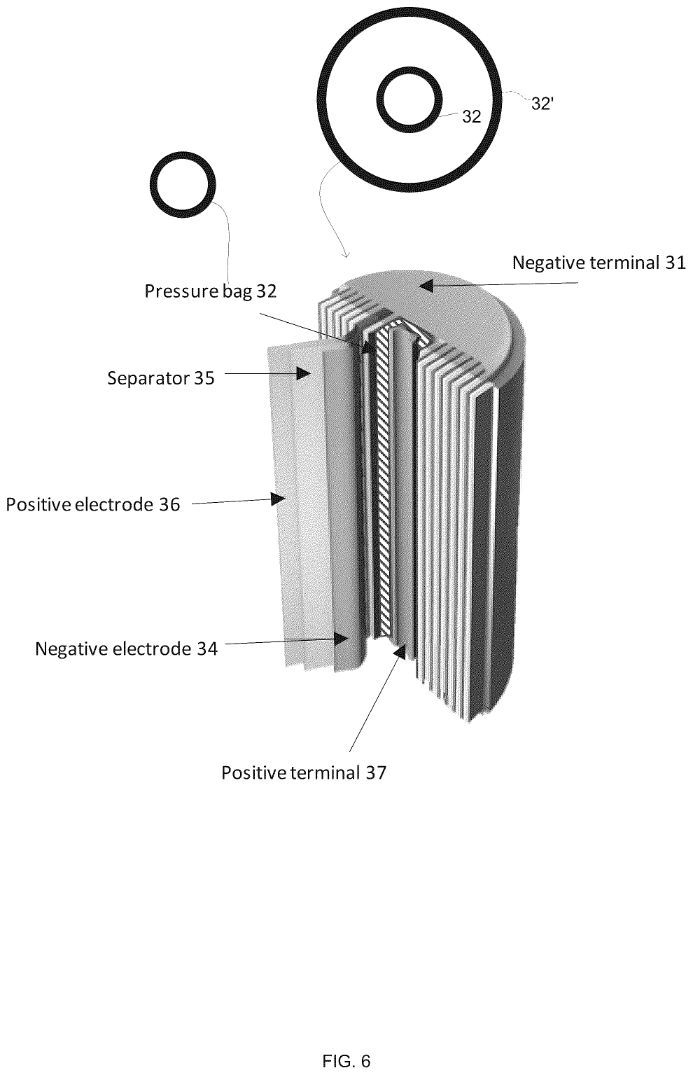

FIGS. 5-6 illustrate examples of cylindrical electrochemical cells;

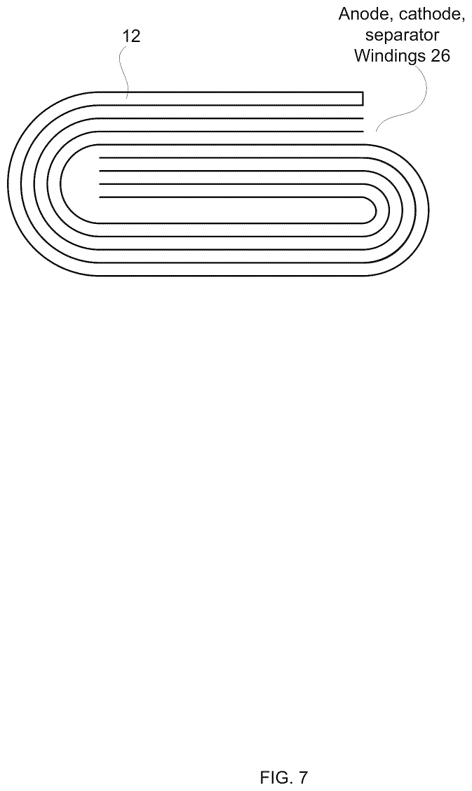

FIG. 7 illustrates an example of a prismatic electrochemical cell having prismatic windings and without its rigid housing;

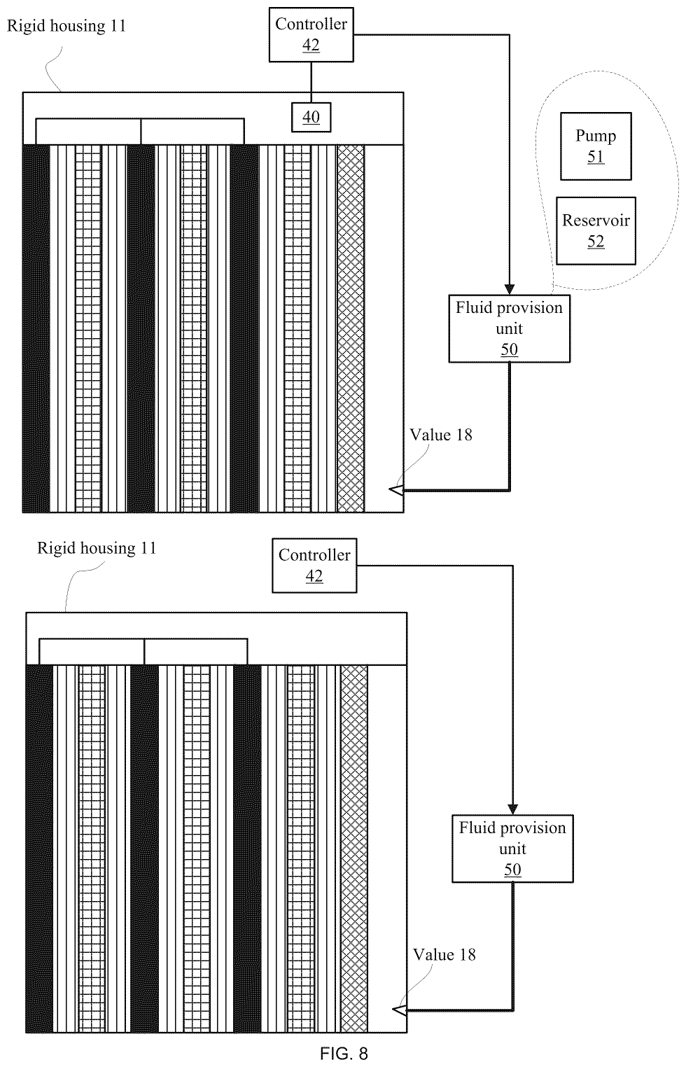

FIGS. 8-10 illustrate examples of a device that includes prismatic electrochemical cells that includes electrodes and separator sheets and various elements located outside the prismatic electrochemical cell;

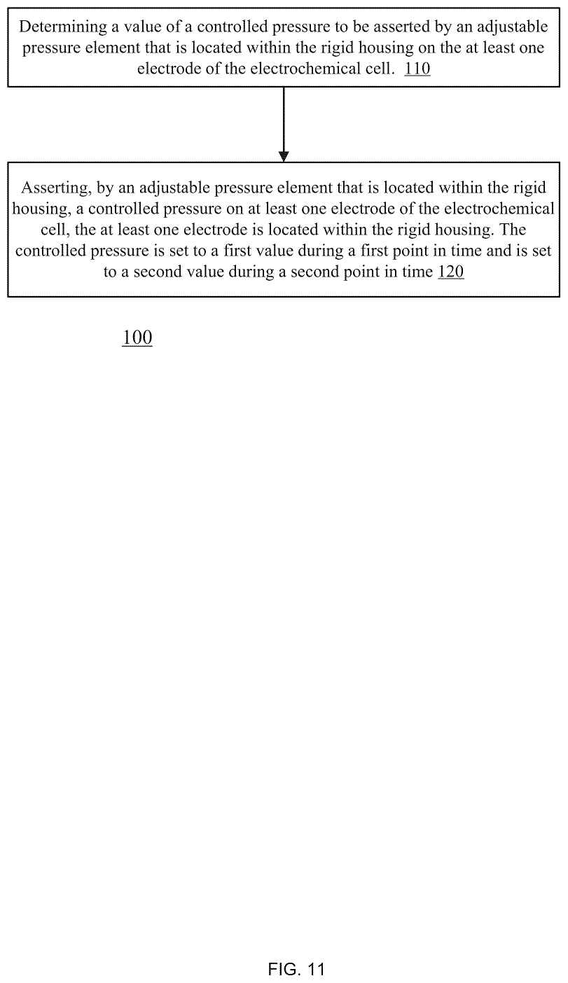

FIG. 11 illustrates an example of a method;

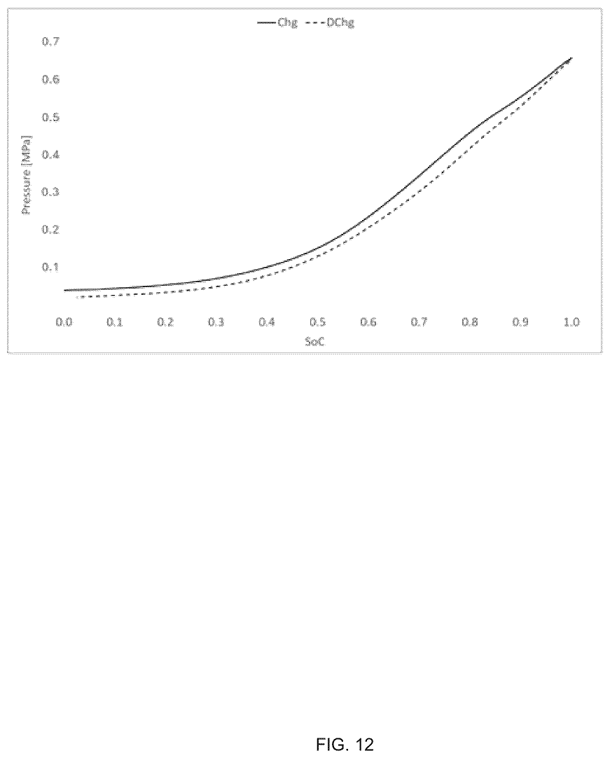

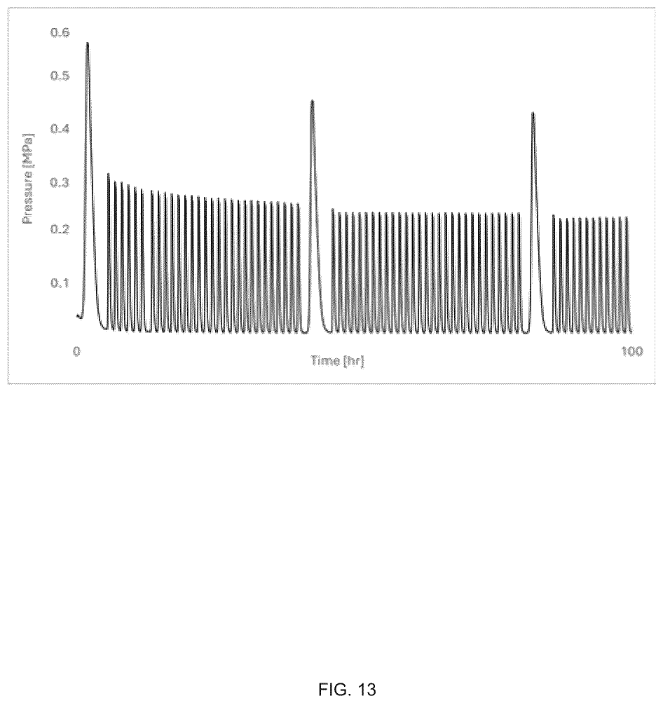

FIGS. 12-13 illustrate test results; and

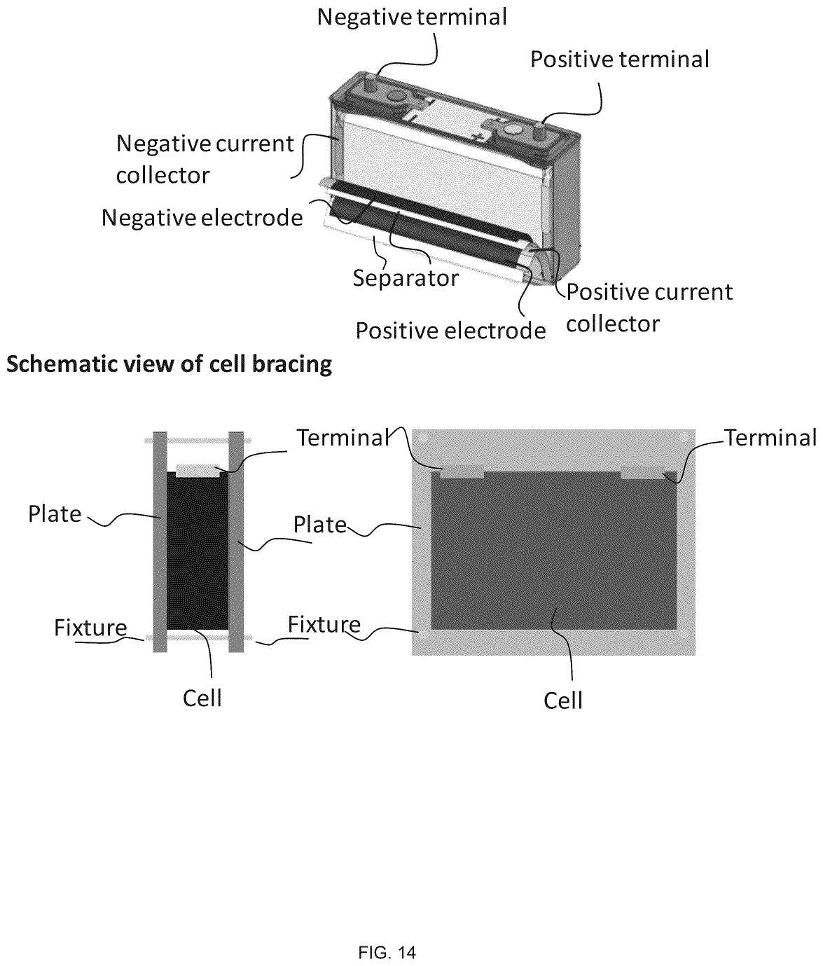

FIGS. 14-16 illustrate examples of applying pressure from the exterior of a prismatic cell.

### DETAILED DESCRIPTION

### Formation

The formation process is the first one or more cycles of a lithium-ion battery. During formation, a solid electrolyte interphase (SEI) layer forms on the surface of the electrodes. It should be noted that additional processes occur during the formation-for example electrolyte wetting into the electrode pores, activation of electrode materials, and stabilization of the cell structure. The SEI layer is a protective layer that prevents electrolyte decomposition and improves the battery's performance.

In general, silicon anode batteries require a longer formation process than graphite anode batteries. This is because the SEI layer on silicon is more fragile and needs more time to mature. Applying pressure during formation can help to stabilize the SEI layer and improve the battery's performance, especially for silicon and lithium metal batteries.

### Cycling

The cycling process in a lithium-ion battery is the repeated process of charging and discharging. During this process, lithium ions shuttle back and forth between the anode and cathode, generating and storing electrical energy. As lithium ions are inserted and removed from the anode material during cycling, the material undergoes volume changes. This causes the anode to expand and contract. This is because the crystal structure of the anode expands to accommodate the incoming lithium ions and contracts as they leave. Silicon and lithium metal anodes undergoes much more expansion and contraction than graphite, which can lead to mechanical stress, particle cracking, electrolyte interface instability and lithium dendrite growth. The dendrites are needle-like structures that can pierce the separator, causing short circuits and potential safety hazards.

Applying pressure during cycling can help to mitigate these effects and improve the battery's lifespan.

### External Pressure

The amount of pressure that needs to be applied to a silicon or lithium metal anode battery depends on the specific material, electrode structure and cell configuration (electrolyte type, cell format, and the like). The pressure level is typically in the range of 0.1-100 MPa.

Specifically, the pressure helps to silicon anode:
a. Reduce particle cracking: By applying external pressure, the anode material is kept in a more compressed state, reducing the internal strain caused by the lithium ion insertion and de-insertion process. This minimizes particle cracking and overall structural degradation.
b. Improve contact between particles: The pressure helps to press the silicon particles together, improving electrical conductivity, lithium ion diffusion, reducing the internal resistance of the anode and strain on the binder and particles, and enhancing structural stability
c. Enhance lithium diffusion: The pressure can help to create a more uniform lithium distribution within the silicon particles, facilitating faster and more efficient lithium diffusion during cycling.
d. Stabilize the SEI layer: SEI is a protective film that forms on the surface of the silicon particles and prevents electrolyte decomposition. The pressure can help to stabilize the SEI layer, reducing its growth and improving its lithium ion conductivity.
e. Maintains electrode-electrolyte contact: The pressure helps to maintain this contact, ensuring efficient lithium ion movement and higher charge/discharge capacity.

Specifically, the pressure helps to lithium metal anode:
a. Control the morphology of the deposited lithium metal: Pressure can help to prevent the formation of lithium dendrites, which are needle-like structures that can pierce the separator and cause a short circuit and safety hazards.
b. Stabilizing the SEI films: Pressure can help to spread out the lithium metal during the deposition process, which can reduce the formation of thick SEI films.
c. Improved contact with electrolyte: The pressure can maintain good contact between the lithium metal anode and the electrolyte, even as the electrode surface changes during cycling. This ensures efficient lithium ion transport and minimizes the formation of isolated “dead zones” where lithium ions are trapped and unable to participate in cycling. Reducing mechanical stress: The pressure helps to compress the electrode, reducing this stress and minimizing the risk of cracks or fractures that can degrade performance and shorten lifespan.

According to an embodiment, the applying of pressure is highly beneficial in the

development not only liquid electrolyte cells but also for various types of solid-state batteries, like semi-solid-state and quasi-solid-state batteries.

In solid-state batteries, the pressure can play a significant role in enhancing the performance and lifespan by suppression of lithium dendrite growth, improved interfacial contact and electrical contact between particles, enhancing lithium diffusion, reducing cracking and crushing, and mitigation volume expansion/contraction.

It should be noted that applying too much pressure can be counterproductive, leading to electrolyte leakage or damage to the battery components. There is a need to tailor the pressure for each specific solid-state battery configuration. The tailoring use measurement, simulations, and the like.

Applying external pressure on prismatic electrochemical cells and cylindrical electrochemical cells is inefficient—as these types of electrochemical cells have a rigid housing. Rigid housings resist deformation, making it difficult to apply and maintain uniform pressure across the entire electrode surface. This can lead to uneven pressure distribution, hindering the desired effects on lithium dendrite growth, interfacial contact, and other factors. Moreover, applying external pressure can create significant stress on the rigid housing and cell components, potentially leading to cracks, leaks, or even catastrophic failure.

Applying a homogeneous external pressure on electrochemical cells that have rigid housings that include windings (that are curved or have curved portions-instead of having flat anode and cathode sheets) is even more complicated.

The pressure applied to an electrochemical cell should be uniform and well-distributed to prevent damage to the electrodes of the electrochemical cell.

The uniformity and well-distributed pressure is particularly important for silicon and/or lithium-metal anode batteries, as they experience significant volume changes during the formation process.

External pressure applied to the outer surfaces of the rigid housing may not be effectively transferred to the interior, resulting in uneven expansion and contraction of the silicon and/or lithium-metal anode. This can lead to particle cracking and reduced battery performance.

Similarly, in cylindrical cells, the curved shape makes it difficult to apply uniform pressure. Applying external pressure to the rigid housing of the cylindrical cell can cause stress concentrations at the corners and edges, leading to electrode damage. Additionally, the pressure applied to the cylindrical cell may not be effectively transferred to the interior due to the hollow structure of the cylindrical cell.

Moreover, the volume change of the electrochemical cell before and after formation makes it especially difficult to apply external pressure to silicon lithium-ion cells having prismatic or cylindrical form factors. During the formation process, the silicon anode undergoes significant expansion and contraction due to the insertion and removal of lithium ions. This volume change can cause the cell to deform or swell, which can make it difficult to maintain uniform pressure.

In addition to the volume change, the silicon and lithium metal anode also has a lower mechanical strength than graphite. This means that the silicon anode is more susceptible to damage from external pressure. Applying too much pressure can cause the silicon particles to crack, which can lead to capacity loss and reduced battery life.

As a result of these challenges, it is important to carefully control the pressure level applied on the electrochemical cell—and especially on one or more electrodes of the electrochemical cell.

According to an embodiment there is provided a device that includes an adjustable pressure element that is configured to apply (from within the rigid housing) a uniform pressure distribution to prevent any areas from being overstressed or under stressed.

According to an embodiment the pressure applied by the adjustable pressure is controlled by a controller—to avoid damaging the electrodes.

According to an embodiment there are multiple adjustable pressure elements within the rigid housing.

According to an embodiment the adjustable pressure element is an inflatable bag that changes its volume based on the amount of gas provided to the bag. The bag conforms to the shape of the cell and provides a uniform pressure distribution.

According to an embodiment the gas is provided to the bag using a fluid provision unit 50 that supplies gas through an interface such as value 18. The fluid provision unit may include at least one of a gas pump, a compressor or any other gas source and/or includes gas fluid control elements such as a valve to determine the gas pressure within the bag.

According to an embodiment the amount of gas is determined by applying one or more policies such as maintaining a constant pressure to be applied by the bag, changing the pressure over time, maintaining a constant volume of the bag (for example for maintaining a constant gap between opposite sides of the bag), maintaining a fixed gap between elements of the electromechanical cell, allowing a defined change of volume of the bag over time, and the like.

The policy may define different pressure and/or volume parameters during different points in time-for example during forming versus cycling, during different phases of lifespan of the electrochemical cell, and the like.

According to an embodiment a solution may involve:
a. A gas pump uses a motor to compress gas.
b. The compressed gas is then stored in the bag.
c. The pressure of the gas is controlled by adjusting an opening of the valve.
   When a valve is opened, the compressed gas is released from the bag. As an option gas can be released into the reservoir or tank for more flexibility of pressure control.

The controlling of pressure may be responsive to readings of one or more sensors-or may be determined without using sensor readings.

A sensor may be located within the electrochemical cell or outside the electrochemical cell.

Examples of sensors include a temperature sensor, a volume sensor, a cycle sensor, a pressure sensor, a state of health sensor, a formation of SEI sensor, an expansion of electrodes sensor, and the like.

The reservoir or tank can be cooled by any possible options, such as radiator, heat exchanger, air and/or liquid, then the gas can be used as a cooling agent for the cell/battery.

The proposed cooling can be a primary or supplementary.

Thermal propagation is a serious safety concern with batteries, especially lithium-ion batteries. It occurs when a single cell undergoes thermal runaway, generating significant heat that can transfer to adjacent cells, causing them to also undergo thermal runaway in a chain reaction. This can lead to fire and explosion, posing a significant risk.

According to an embodiment using the fluid to cool the electrochemical cell reduces the risk of propagation of the thermal runaway.

According to an embodiment, the bag is made of a polymer.

According to an embodiment, the polymer is selected based on one of more of the following parameters:
a. Heat insulation. Certain polymers act as thermal insulators, delaying the transfer of heat from a cell in thermal runaway to its neighbors. This provides valuable time for safety mechanisms to activate and prevent the propagation.
b. Heat sinks. A polymers can be designed to act as a heat sink, absorbing and dissipating heat away from the electrochemical cell. This can reduce the overall temperature of the battery pack and prevent thermal runaway from occurring. According to an embodiment, a polymer may be designed as a heat sink by:
   i. Polymer matrix manipulation. The intrinsic thermal conductivity of polymers is generally lower than metals. However, polymer matrices can be modified by incorporating thermally conductive fillers like ceramic particles, carbon nanotubes, or graphene. These fillers create pathways for heat to travel more efficiently within the polymer.
   ii. Polymer blends: Blending different polymers with varying thermal conductivities can also create a composite material with improved heat transfer properties.

The polymer may be a phase change material (PCMs). PCMs are materials that absorb and release large amounts of heat at specific temperatures. They can be incorporated into the battery design to absorb heat generated during a thermal runaway event, preventing it from reaching neighboring cells.
a. The incorporation may involve:
   i. Microencapsulation. PCMs can be microencapsulated within the “bag” materials themselves. During a thermal runaway event, the PCMs absorb the excess heat by melting, preventing it from reaching critical temperatures and triggering further cell degradation. Once the temperature cools down, the PCMs solidify again, releasing the stored heat.
   ii. PCM-filled cooling channels. Channels embedded within the battery pack can be filled with PCMs. These channels act as heat pipes, drawing heat away from the cells through direct contact or via heat pipes. The absorbed heat is then released outside the battery through fins or other heat dissipation mechanisms.
   iii. PCM surface coatings: A thin layer of PCM can be directly applied to the bag or battery cell surface. This coating absorbs heat during a thermal runaway event, protecting the cell from reaching critical temperatures.
b. Intumescent materials: These materials expand and char when exposed to heat, creating a barrier that can prevent the spread of flames and toxic gases.

However, the effectiveness of polymers in mitigating thermal propagation depends on several factors, including:
a. The type of polymer used. Different polymers have different thermal properties, such as conductivity and heat capacity. The specific properties required will depend on the specific battery design and application. For example, polymers with exceptional thermal stability (Tg>150° C.) and high heat capacity (>4 kJ/kg*K) are crucial. Polyetheretherketone (PEEK), Polyphenylene sulfide (PPS), and some modified polyesters are good options.
b. The thickness and location of the polymer. Thicker layers will provide better insulation but may also hinder heat dissipation. The placement of the polymer within the battery pack is also crucial for optimal effectiveness. For example: (i) both the thickness and location of the polymer play a role in achieving this balance. (ii) Thickness: pros of thicker layers: Enhanced insulation—a thicker polymer layer naturally provides greater resistance to heat transfer, effectively delaying the spread of heat from a runaway cell to its neighbors. This buys valuable time for safety mechanisms to activate and prevent further propagation. Higher heat capacity. Thicker layers can absorb more heat before their temperature rises significantly, offering additional protection against rapid thermal runaway events. Cons of thicker layers: reduced heat dissipation—thicker layers can hinder overall heat transfer from the battery pack, potentially leading to higher operating temperatures under normal conditions. This can impact battery performance and long-term stability. Increased weight and volume-thicker polymers add to the overall weight and size of the battery pack, which might be undesirable for certain applications, especially portable electronics.
c. Location: one direction separation-placing the polymer layer directly between the bag and electrodes. Cell-to-cell separation—the polymer can be incorporated as a lining along the inner walls of the cell housing, for example two bags approach. This provides targeted insulation, effectively blocking heat transfer between adjacent cells during a thermal runaway event.

According to an embodiment the certain polymer is selected to exhibit one of the following:
a. Low thermal conductivity. The polymer should have minimal ability to conduct heat, effectively acting as a barrier between a runaway cell and its neighbors. As an example, polymers with thermal conductivity values in the range of 0.02-0.2 W/mK or lower. Common examples include polyolefins (PE, PP), polystyrenes (PS), and fluoropolymers (PTFE).
b. High heat capacity. The polymer should be able to absorb a significant amount of heat before its temperature rises significantly. This provides more time for safety mechanisms to kick in and prevents rapid heat transfer to surrounding cells. As an example, polymers with high specific heat capacities (around 2-4 kJ/kg*K) are preferred. Materials like polyimides, polyetherketones (PEK), and some polyesters fall into this category.
c. Thermal Stability. The polymer should remain stable and not degrade at the elevated temperatures encountered during a thermal runaway event. Decomposition could release additional heat, worsening the situation. As an example, polymers with high glass transition temperatures (Tg) and melting points, ideally exceeding the expected runaway temperature of the battery. High-performance polymers like PEEK, PPS, and some polyamides excel in this aspect.
d. Mechanical Properties. The polymer should possess appropriate mechanical strength and resilience to withstand the pressure and expansion forces generated during a thermal runaway event. As an example, polymers with good tensile strength, tear resistance, and dimensional stability are preferred. Options like polyurethanes (PU) and reinforced composites can be viable in certain designs.
e. Flame retardancy. Polymers with inherent flame retardant properties can further enhance battery safety by preventing fire propagation in case of a severe thermal event.

According to an embodiment the certain polymer is selected from multilayer structures: Combining polymers with different properties, such as low thermal conductivity and high mechanical strength, can create effective composite materials for the pressure element.

According to an embodiment the adjustable pressure element is a mechanical positioning unit that mechanically moves a plate thereby determining the pressure applied on one or more electrode of the electrochemical cell.

According to an embodiment, the mechanical positioning unit includes an internal spring-loaded mechanism. Spring-loaded mechanisms can apply pressure to the cell while accommodating volume changes.

FIG. 1 illustrates the prismatic electrochemical cell as including a rigid housing 11, multiple repetitions of a cathode sheet 15, separator sheet 16, anode sheet 17, and another separator sheet. The prismatic electrochemical cell also includes a plate 13 and a bag 12 having a valve 18. The bag applies a controlled pressure on the plate 13 that is used for homogenizing the pressure applied on multiple repetitions. FIG. 1 also illustrates taps 14 for electrically coupling the cathodes sheets to each other.

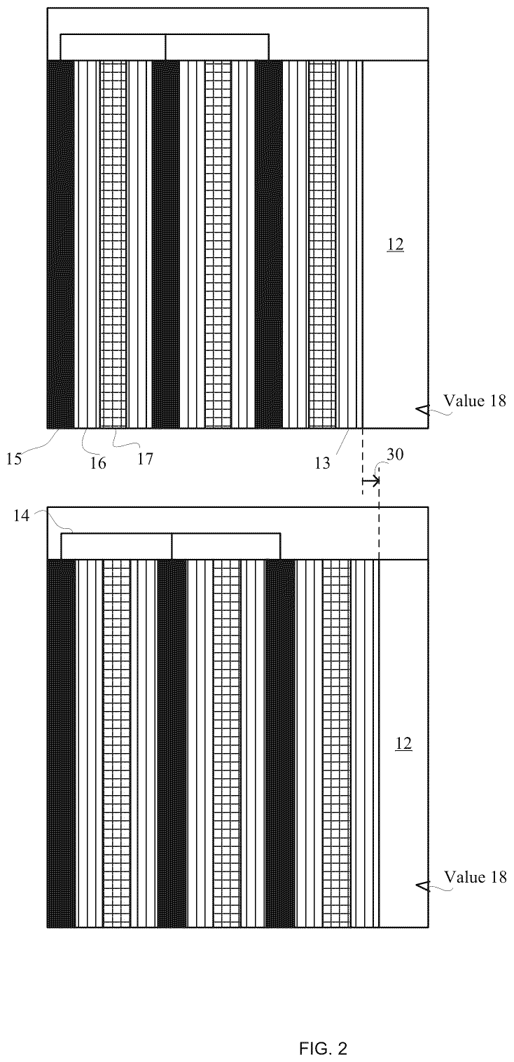

FIG. 1 also illustrates the prismatic electrochemical cell as including a rigid housing 11, multiple repetitions of a cathode sheet 15, separator sheet 16, anode sheet 17, and another separator sheet. The prismatic electrochemical cell also includes a plate 13 and a bag 12 having a valve 18 are located to the right of the multiple repetitions. The bag applies a controlled pressure on the plate 13 that is used for homogenizing the pressure applied on multiple repetitions. FIG. 2 also illustrates taps 14 for electrically coupling the cathodes sheets to each other. FIG. 2 further illustrates a second bag 22 located to the left of the multiple repetitions. The second bag applies a controlled pressure on the second plate 23 that is used for homogenizing the pressure applied on multiple repetitions by the second bag. The bag and the second bag may be controlled independently or in synchronization with each other. The value of the second bag was not shown for simplicity of explanation. According to an embodiment the valve may be shared by both bags.

FIG. 2 illustrates the prismatic electrochemical cell of figure at two different states—and illustrates that the multiple repetitions may expand over time (see arrow 30).

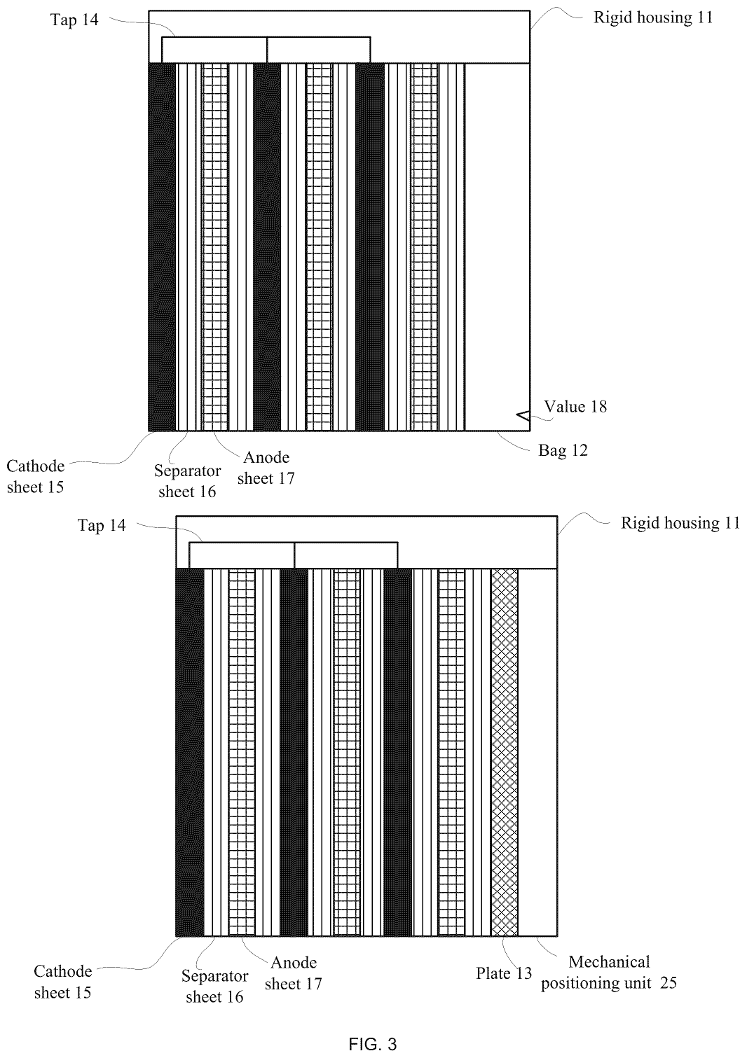

FIG. 3 illustrates a prismatic electrochemical cell as including a rigid housing 11, multiple repetitions of a cathode sheet 15, separator sheet 16, anode sheet 17, and another separator sheet. The prismatic electrochemical cell also includes a bag 12 having a valve 18. The bag applies a controlled pressure on the multiple repetitions. FIG. 3 also illustrates taps 14 for electrically coupling the cathodes sheets to each other. There is no plate within the prismatic electrochemical cell.

FIG. 3 also illustrates a prismatic electrochemical cell as including a rigid housing 11, multiple repetitions of a cathode sheet 15, separator sheet 16, anode sheet 17, and another separator sheet. The prismatic electrochemical cell also includes a mechanical positioning unit 25 and a plate 13. The mechanical positioning unit 25 is configured to position the plate at a desired location thereby controlling the pressure applied by the plate on the multiple repetitions. FIG. 3 also illustrates taps 14 for electrically coupling the cathodes sheets to each other. There is no plate within the prismatic electrochemical cell.

FIG. 4 provides an isometric view of an interior of the prismatic electrochemical cell of FIG. 1.

FIGS. 5-6 illustrate examples of cylindrical electrochemical cells. FIG. 5 illustrates a pressure bag (also referred to as bag) 32 that surrounds the windings (each winding includes a positive electrode 36, a negative electrode 24 and one or more separator 35) and is located within the negative terminal. FIG. 6 illustrates the pressure bag 32 that is surrounded by the windings and surrounds the positive terminal 37.

FIG. 7 illustrates an example of a prismatic electrochemical cell having prismatic windings (denoted anode, cathode, separator windings 26) surrounded by bag 12.

FIGS. 8-10 illustrate examples of a device that includes a prismatic electrochemical cell and various elements located outside the prismatic electrochemical cell.

While FIG. 8-10 illustrates a prismatic electrochemical cell that includes electrodes and separator sheets—the various elements located outside the prismatic electrochemical cell are usable in any other electrochemical cell—such as the electrochemical cells of FIGS. 5-7.

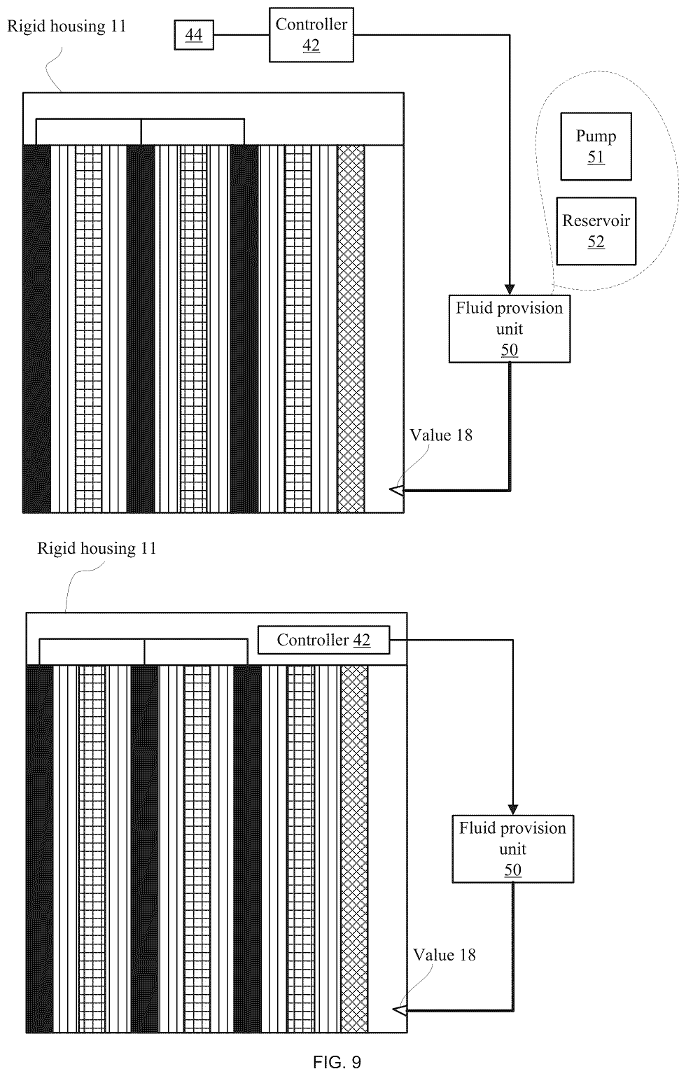

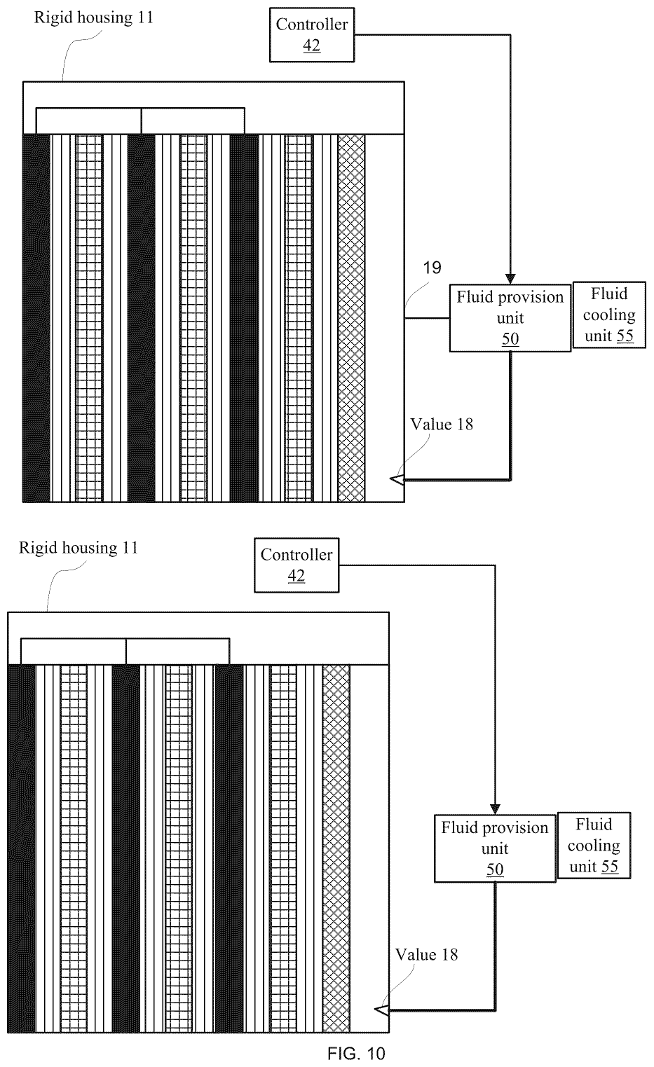

The various elements include at least one elements out of:
a. Controller 42 for controlling the pressure. The controller may be located within the rigid housing (FIG. 9) or outside the rigid housing.
b. Fluid provision unit 50 for providing the fluid and/or extracting the fluid from the bad. The fluid provision unit 50 is in fluid communication with valve 18 and/or any other opening of the bag (see for example additional opening 19 of FIG. 10). The fluid provision unit 50 may include a fluid source such as pump 51 or compressor, and any other fluid control element such as reservoir 52.
c. One or more sensors—such as an inner sensor 40 (FIG. 8) located within the rigid housing, external sensor 44 (FIG. 9) located outside the rigid housing.
d. Fluid cooling unit 55 for cooling the fluid.

The fluid may be gas, may be liquid of a combination thereof. Gas is easier to compress.

FIG. 11 illustrates an example of a method 100 for operating any of the electrochemical cells illustrated in the application.

Method 100 is for controlling pressure within an electrochemical cell having a rigid housing.

According to an embodiment, method 100 includes step 120 of asserting, by an adjustable pressure element that is located within the rigid housing, a controlled pressure on at least one electrode of the electrochemical cell, the at least one electrode is located within the rigid housing. The controlled pressure is set to a first value during a first point in time and is set to a second value during a second point in time.

According to an embodiment, method 100 also includes step 110 of determining a value of a controlled pressure to be asserted by an adjustable pressure element that is located within the rigid housing on the at least one electrode of the electrochemical cell.

Various experiments were conducted in order to test some of the techniques mentioned above.

Table 1 summarizes results of the formation under different pressure applied on 3 Ah stacked cell with Si-based anode, NMC811 cathode and organic liquid electrolyte. The initial pressure was 0.7 MPa at 0% SOC. The cycling was performed under the same procedure 1C/1C (charge/discharge rate), ambient temperature 24° C.

TABLE 1

| | Constant | No | Non-uniform |
|---|---|---|---|
| | gap* | pressure | pressure* |
| Cycle life, | 1,500 | Failed to | Few cycles |
| with 80% | | run cycles | |
| capacity retention | | | |

Table 2 summarizes results of the 1C/1C, ambient temperature 24° C., cycle life under different pressure applied on 30 Ah stacked cell with Si-based anode, NMC811 cathode and organic liquid electrolyte. The initial pressure was 0.2 MPa at 0% SOC. All cells performed the same formation process (under constant gap conditions, refer to Table 1).

TABLE 2

| | Constant | Constant | No | Non-uniform |
|---|---|---|---|---|
| | pressure | gap* | pressure | pressure* |
| Cycle life, | 800 | 1,500 | 250 | 520 |
| with 80% | | | | |
| capacity retention | | | | |

*Initially the same pressure was applied when applying constant gap and non-uniform pressure.

FIG. 12 illustrates the “breathing pressure” during single 1C/1C charge discharge cycle, ambient temperature 35° C., for 30 Ah stacked cell with Si-based anode, NMC811 cathode and organic liquid electrolyte. The initial pressure was 0.4 MPa at 0% SOC, that was held at constant gap.

FIG. 13 illustrates the “breathing pressure” during multiple 1C/1C charge discharge cycles (every 29^{th} cycles was done under fast charge conditions at 4.2C 10-80% SOC and 1C discharge), ambient temperature 35° C., for 30 Ah stacked cell with Si-based anode, NMC811 cathode and organic liquid electrolyte. The initial pressure was 0.4 MPa at 0% SOC, that was held at constant gap.

### Applying Pressure from the Exterior of a Prismatic Cell

Silicon anodes in lithium-ion cells experience significant swelling during formation and cycling due to the large volume change when lithium ions are inserted and removed. Applying mechanical pressure can be beneficial in this case.

Benefits of applying mechanical pressure to silicon anode cells:
a. Reduced swelling: Pressure helps counteract the expansion of the silicon anode, mitigating mechanical stress and strain on the electrode structure. This can lead to:
b. Improved cycle life: By reducing mechanical degradation, pressure can extend the number of charge-discharge cycles the cell can undergo before losing capacity.
c. Enhanced capacity retention: Less swelling means less loss of electrode contact and active material, potentially leading to better capacity retention over extended use.
d. Improved safety: Reduced stress and strain can minimize the risk of electrode cracking, electrolyte leakage, and other safety concerns.
e. Improved cell resistance—pressure helps improve the electrical contact between the silicon particles in the anode and the current collector, as well as with the electrolyte interface, facilitating better ion transport. As a result, faster charging and discharging is possible.
f. Potentially faster formation: Pressure can optimize electrode contact and electrolyte distribution, potentially leading to a faster and more efficient formation process.
   Things to consider when applying pressure:
a. Pressure level: Too much pressure can damage the delicate electrode structure and negatively impact performance. Finding the optimal pressure for a specific cell configuration and material is crucial.
b. Uniformity: The pressure needs to be evenly distributed across the cell to avoid localized effects and potential problems.
c. Manufacturing complexity: Implementing pressure application adds complexity to the manufacturing process, requiring specialized equipment and careful control.
d. Long-term effects: The long-term impact of pressure on cell degradation and safety needs careful evaluation for each specific case.

FIGS. 14-16 illustrate examples of a prismatic cell and applying external pressure.

### Referring to FIG. 14

a. The location of the terminals on a prismatic Li-ion cell can vary depending on the specific cell design. There are two main configurations: Terminals on the top and bottom; Terminal on the same side.
b. The electrode assembly processes includes:
   i. Winding: It involves coiling the electrode assembly into a tightly rolled structure before inserting it into the cell casing.
   ii. Stacking: The electrode assembly is built by individually placing and layering the electrode sheets and separators before pressing them together.
   iii. Hybrid approaches: It combines elements of both methods for specific applications.

In should be noted that in FIG. 14 the plate is partially transparent to reveal the cell behind the plate—for convenience of explanation.

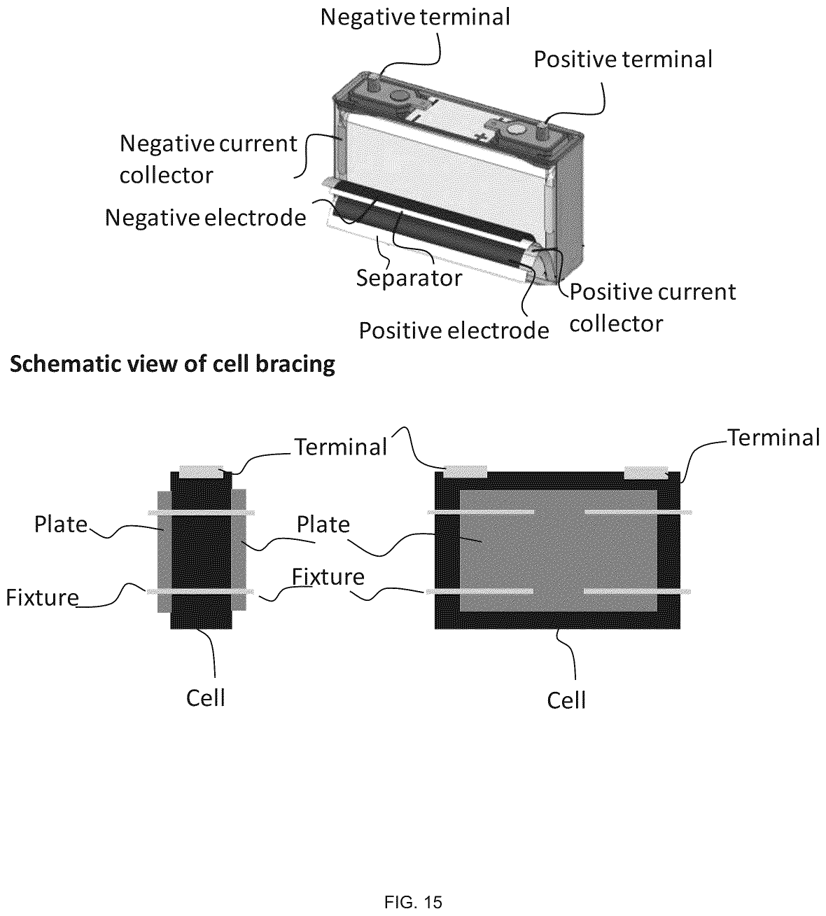

### Referring to FIG. 15:

a. Li-ion prismatic cells do have a difference in rigidity along their structure, particularly at the corners compared to the middle.
b. The stacked electrodes in prismatic cells can lead to a “bath-like” curvature in swollen electrodes, especially if the welding tabs are located on opposite sides.
c. In this case, the pressure plates are smaller than the entire cell to target the curvature center.
d. In addition, curved pressure plates could be used to address the challenges of “bath-like” curved electrodes in stacked prismatic cells.

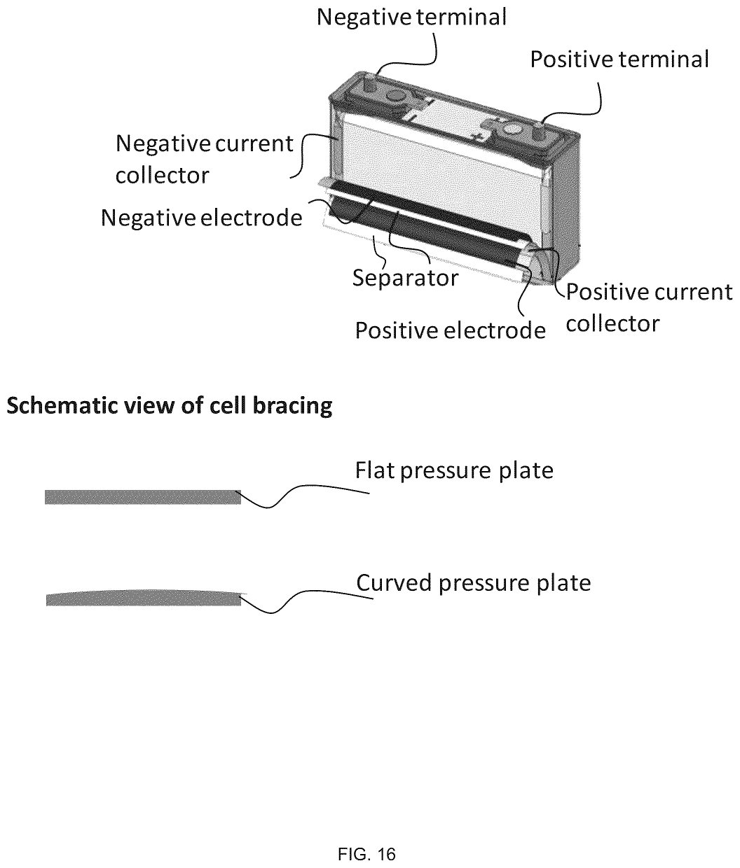

### Referring to FIG. 16

a. Li-ion prismatic cells do have a difference in rigidity along their structure, particularly at the corners compared to the middle.
b. The stacked electrodes in prismatic cells can lead to a “bath-like” curvature in swollen electrodes, especially if the welding tabs are located on opposite sides.
c. Curved pressure plates could be used to address the challenges of “bath-like” curved electrodes in stacked prismatic cells.

It should be noted that prismatic cells exhibit a packing ratio, or stack-to-can ratio, that is a significant parameter in battery design, particularly when comparing soft and prismatic cells.

The packing ratio is defined as the thickness ratio between the dry electrode stack before formation and the inner can in the final cell.
A higher packing ratio indicates a denser electrode stack, leading to:
   Increased energy density: More active material packed into the cell translates to higher capacity per unit volume.
   Potential challenges: In the case of silicon or lithium metal anode, as the stack will start swelling in the formation process it will apply outwards pressure that is higher than what the prismatic can will be able to constrain. Plastic deformation of the prismatic cell will significantly challenge its integration into a pack, and can also lead to a mechanical failure of the can itself or the sealing to the cap.
A lower packing ratio results in a less dense stack:
   Lower energy density: Limited active material but could improve safety and cycle life.
   Potential challenges: In the case of silicon or lithium metal anode, as the stack will start swelling in the formation process, there will be nothing to constrain it—1^{st} charge irreversible reactions and significant swelling is expected. Additionally, low packing ratio will not allow external pressure to be applied on stack also during operation which eventually will lead to poor electrochemical performance.

The suggested solution is adapted to resolve said problems of a prismatic cell regardless of the packing ratio.

In the foregoing detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter that is regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method.

Any reference in the specification to a system or device should be applied mutatis mutandis to a method that may be executed by the system.

Any combination of any module or unit listed in any of the figures, any part of the specification and/or any claims may be provided.

Any combinations of systems, units, components, processors, sensors, illustrated in the specification and/or drawings may be provided.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

In the foregoing specification, the invention has been described with reference to specific examples of embodiments of the invention. It will, however, be evident that various modifications and changes may be made therein without departing from the broader spirit and scope of the invention as set forth in the appended claims.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations are merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also, for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps than those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Rather the scope of the embodiments of the disclosure is defined by the appended claims and equivalents thereof.

We claim:

1. A device, comprising:
an electrochemical cell that comprises: a rigid housing, electrodes that comprises an anode, a cathode, and an adjustable pressure element configured to assert a controlled pressure on at least one of the electrodes: wherein the controlled pressure is set to a first value during a first point in time and is set to a second value during a second point in time: wherein the electrodes and the adjustable pressure element, are located within the rigid housing.

2. The device according to claim 1, wherein the adjustable pressure element comprises a bag that is filled with a controlled amount of gas, the amount of gas corresponds to the value of the controlled pressure.

3. The device according to claim 1, wherein the adjustable pressure element comprises a spring-loaded mechanism.

4. The device according to claim 1, further comprising a controller that is configured to set a value of the controlled pressure.

5. The device according to claim 4, wherein the adjustable pressure element comprises a bag that stores a controlled amount of gas.

6. The device according to claim 5, wherein the bag comprises a controlled value that is in fluid communication with a pressure control unit.

7. The device according to claim 4, wherein the controller is located outside the electrochemical cell.

8. The device according to claim 4, further comprising a sensor, wherein the controller is configured to determine the controlled pressure value based on a reading of the sensor.

9. The device according to claim 4, wherein the controller comprises a gas reservoir in fluid communication with the pressure control unit.

10. The device according to claim 4, wherein the controller is configured to set the controlled pressure to a first value during a formation point in time and to a second value during a cycling point in time, the first value differs from the second value.

11. The device according to claim 4, wherein the controller is configured to set the controlled pressure based on a state of health (SOH) of the electrochemical cell.

12. The device according to claim 4, wherein the controller is configured to set the controlled pressure to maintain, during a given time period, a distance between a side of the adjustable pressure element that interfaces the rigid housing and an opposite side of the adjustable pressure element.

13. The device according to claim 4, wherein the controller is configured to set the controlled pressure to maintain, during a given time period, a value of the controlled pressure.

14. The device according to claim 1, comprising a cooling element configured to receive a cooled fluid, pass the cooled fluid within an internal path that passes through the device and output the cooled fluid.

15. The device according to claim 1, further comprising an additional adjustable pressure element that is also configured to assert the controlled pressure on one or more electrode of the electrodes: wherein the additional adjustable pressure element is also located within the rigid housing.

16. The device according to claim 1, comprising a plate that is pressed by the adjustable pressure element against the electrodes.

17. An electrochemical cell, comprising:
a rigid housing:
electrodes that comprises an anode and a cathode; and
an adjustable pressure element configured to assert a controlled pressure on at least one of the electrodes; wherein the controlled pressure is set to a first value during a first point in time and is set to a second value during a second point in time: and
wherein the electrodes and the adjustable pressure element, are located within the rigid housing.

18. A method for controlling pressure within an electrochemical cell having a rigid housing, the method comprising:
asserting, by an adjustable pressure element that is located within the rigid housing, a controlled pressure on at least one electrode of the electrochemical cell, the at least one electrode is located within the rigid housing:
wherein the controlled pressure is set to a first value during a first point in time and is set to a second value during a second point in time.
